(19) United States
(12) Patent Application Publication
(10) Pub. No.: US 2008/0072262 A1
(43) Pub. Date: Mar. 20, 2008

(54) Apparatus for Providing Digital Data

(76) Inventor: Ivan Dimkovic, Karlsruhe (DE)

Correspondence Address: GLENN PATENT GROUP, 3475 EDISON WAY, SUITE L, MENLO PARK, CA, 94025, US

(21) Appl. No.: 11/858,671

(22) Filed: Sep. 20, 2007

Related U.S. Application Data
(60) Provisional application No. 60/826,366, filed on Sep. 20, 2006.

(30) Foreign Application Priority Data
Aug. 6, 2007 (EP) PCT/EP07/06941

(51) Int. Cl. H04N 7/16

(52) U.S. Cl. 725/62

(57) ABSTRACT

An apparatus for providing digital data to a data destination, the apparatus comprising a receiver for receiving digital data and a detector for detecting an interruption event or a provision event. The apparatus further comprising a buffer for buffering digital data and a controller for directing the digital data to the buffer after the interruption event was detected and in case the provision event is detected for providing the digital data from the buffer when digital data is present in the buffer or from the receiver otherwise.

### FIELD OF THE INVENTION

The present invention is in the field of reception and reproduction of digital data, for example display of video data or replay of audio data.

### BACKGROUND OF THE INVENTION

Modern digital lifestyle has recently been improved by the introduction of digital television at home, as well as on mobile personal devices, for example, mobile phones equipped with mobile-TV functionality based on international standards, such as DVB-H (DVB-H=Digital Video Broadcast-Handheld).

State of the art digital television receivers or satellite television receivers are typically equipped with so-called recording capabilities, which enable users to store a certain broadcasted event, which is then scheduled for viewing at a later stage—for example when the user is at home and has free time. Similar conventional systems exist for cable television, where the so-called cable boxes may comprise a recording functionality.

In conventional systems, the recording functionality acts either upon explicit instructions from the user, for example manual programming of the time for recording or in an automatic way by accessing for example a digital channel guide, such as EPG (EPG=Electronic Program Guide), which is typically delivered along with the broadcasted audio visual signal. A typical conventional application of such a program guide would be DVB-T (DVB-T=Digital Video Broadcast Terrestrial).

### SUMMARY OF THE INVENTION

Embodiments provide an apparatus for providing digital data to a data destination, comprising a receiver for receiving the digital data, a detector for detecting an interruption event or a provision event and a buffer for buffering digital data. The apparatus may further comprise a controller for directing the digital data to the buffer after the interruption event was detected, and in case the provision event is detected for providing digital data from the buffer when data is present in the buffer or from the receiver otherwise.

According to another embodiment, the present invention provides a method for providing digital data to a destination, comprising the steps of receiving the digital data, detecting an interruption event or a provision event and buffering digital data. The method further comprises the step of directing the digital data to a buffer after the interruption was detected, and in case the provision event is detected for providing the digital data from the buffer when the data is present in the buffer or from a receiver otherwise.

### SHORT DESCRIPTION OF THE FIGURES

Some embodiments of the present invention will be detailed in the following using the accompanying figures, in which

FIG. 1 shows an embodiment of an apparatus for providing digital data; and

FIG. 2 shows another embodiment of an apparatus for providing digital data.

### DETAILED DESCRIPTION OF THE INVENTION

Conventional systems lack the possibility of time shifting of broadcasts of digital data in case of unplanned events. For example, mobile phones or PDAs (PDA=Personal Digital Assistant) do not support lossless continuation of media services, for example being interrupted by an incoming or also an outgoing phone call.

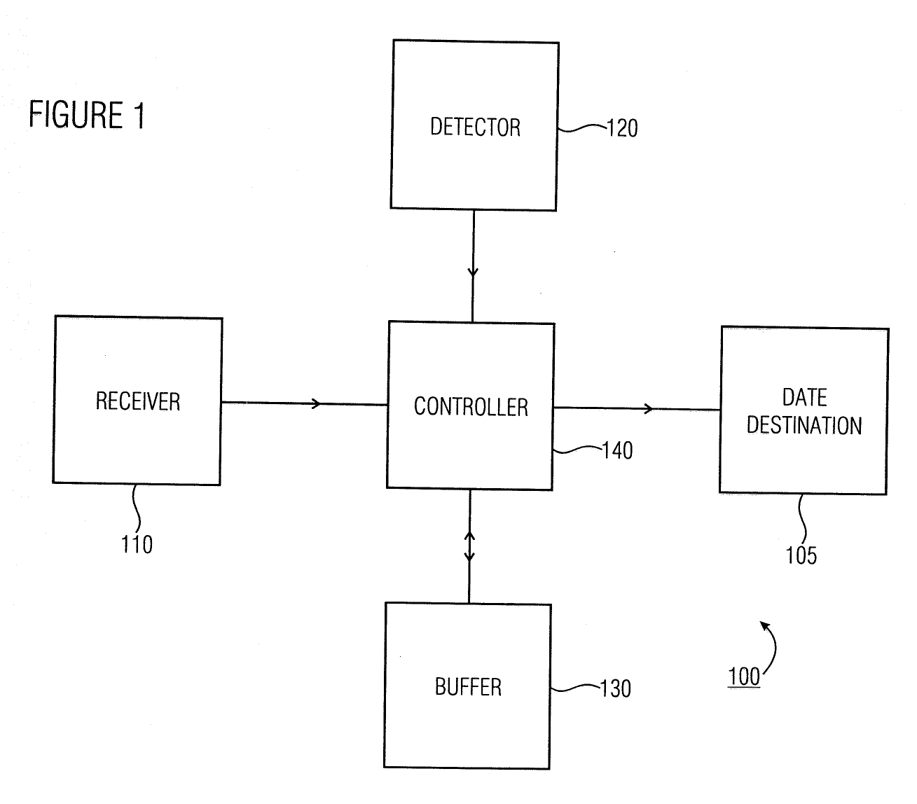

FIG. 1 shows an embodiment of an apparatus 100 for providing digital data to a data destination 105. The apparatus 100 comprises a receiver 110 for receiving the digital data and a detector 120 for detecting an interruption event or a provision event. The apparatus further comprises a buffer 130 for buffering digital data and a controller 140 for directing the digital data to the buffer 130 after the interruption event was detected and in case the provision event is detected for providing the digital data from the buffer 130 when data is present in the buffer 130 or from the receiver 110 otherwise.

In embodiments the receiver 110 can be adapted for receiving digital data according to multiple standards or protocols. For example, the receiver may be adapted for receiving digital data according to one of or a combination of the group of DVB-T, DVB-H, GSM (GSM=Global System for Mobile Communication), UMTS (UMTS=Universal Mobile Telecommunication System), CDMA 2000 (CDMA=Code Division Multiple Access), 3G-systems (3G=Third Generation), LTE (LTE=Long Term Evolution), 802.11 or WLAN (WLAN=Wireless Local Area Network), Bluetooth or IR (IR=Infrared). The receiver 110 can also be adapted to receiving digital data according to an IP (Internet Protocol), TCP (TCP=Transmission Control Protocol), HTTP (HTTP=Hypertext Transfer Protocol), Ethernet or TV-cable connection.

In embodiments, the detector 120 can be adapted for detecting the interruption event or the provision event exclusively. The interruption event may be triggered or may be detected by an incoming or outgoing phone call, as for example on a handheld device. In embodiments the interruption event may also be triggered by a user, for example by a certain button on the handheld device or a remote control.

According to the above description, embodiments of the apparatus 100 can be adapted for buffering digital data after the interruption event was triggered. Embodiments therewith enable continuation of a media service, as for example an audio or video streaming service after an interruption. The video or audio media service, or also any other media service may be received in real time by the receiver 110 and once the interruption event was detected by the detector 120, data is buffered in a buffer 130. If the provision event occurs before an interruption event has occurred, the controller 140 can be adapted for directly forwarding digital data from the receiver 110 to the data destination 105, in which case the buffer 130 may be empty. Once the interruption event occurred, for example by a trigger from the user, the controller 140 is adapted for directing the digital data from the receiver 110 to the buffer 130.

After a certain time period, a user may want to continue the media session and trigger the provision event, for example by ending a phone call or by returning in front of a TV. Once the provision detected the controller. 140 is adapted for directing data from the buffer 130 to the data destination 105, i.e. the reproduction of the data is time shifted. As the media session continues, the controller 140 also continues with directing data from the receiver 110 to the buffer 130, and taking data from the buffer 130 for directing to the data destination 105, in order ensure lossless continuity of the media session.

In other embodiments the controller may also be adapted for always directing a certain amount of digital data from the receiver 110 to the buffer 130, i.e. in these embodiments the interruption event may be triggered as a default setting in advance. These embodiments then enable the user to even return or rewind the media session by a certain amount in time. Generally embodiments may enable full user flexibility with respect to time shifts within a media session in both directions, i.e. in the future and in the past, even if a real time broadcast of the media session is still ongoing and data is still directed to a buffer.

In embodiments the detector 120 may be adapted for detecting the interruption event by an interrupt signal from an application, for example by an application receiving a voice or video call, an e-mail, a short message or any other application, which may as well be configurable by a user.

In embodiments the buffer 130 may comprise a FIFO-buffer (FIFO=First In First Out), a RAM (RAM=Random Access Memory) or a hard drive. In embodiments utilization of any kind of memory is conceivable for buffering the data. Furthermore, in embodiments the buffer 130 may be further adapted for receiving a reset indicator and for deleting buffered data upon reception of the reset indicator. In other embodiments the reset indicator may be dedicated to a certain media session, i.e. when for example using a hard drive, multiple media sessions may be recorded on the hard drive and available from the buffer, and a reset signal may be dedicated to a certain session for deletion.

In other embodiments, the controller 140 may be adapted for transcoding the data received from the receiver 110 before directing the data to the buffer 130. The transcoding can involve data compression which may be lossy, e.g. for audio or video data. For example, when considering a handheld device in a situation, where a user listens to a radio broadcast session when the interruption event occurs, the controller 140 may be adapted for transcoding the audio signal according to a psychoacoustic coding, before directing the coded digital data session to the buffer 130. Consequently, the controller 140 may be adapted for transcoding data from the buffer 130, which is directed to the data destination 105, accordingly, i.e. for decoding or decompressing data from the buffer 130.

Embodiments may for example be comprised in mobile phones, television sets, car entertainment systems, personal computers, etc.

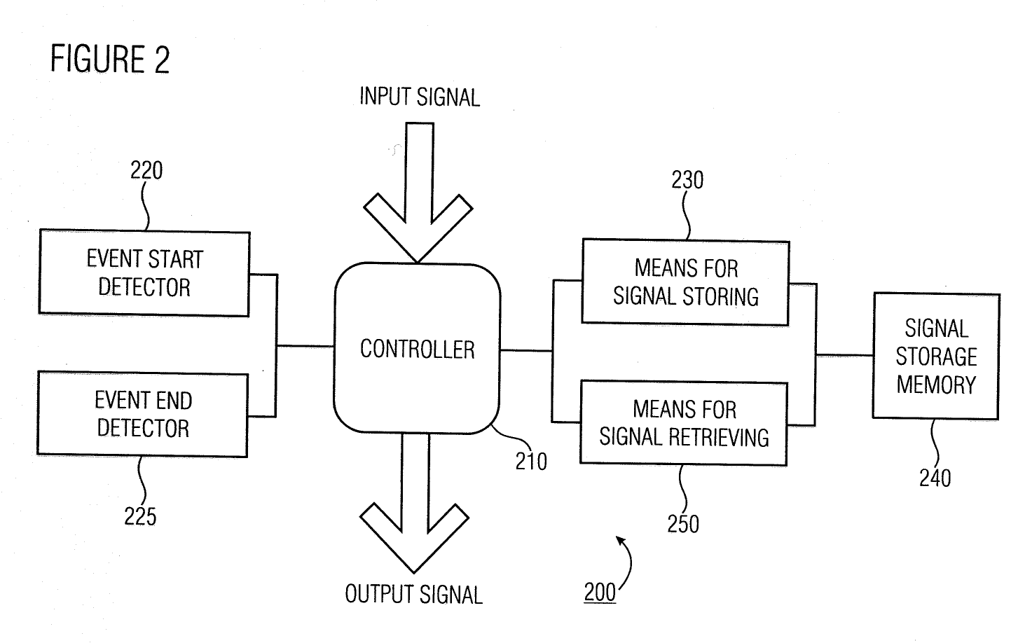

FIG. 2 shows another embodiment of an apparatus 200 for providing digital data. FIG. 2 shows a controller 210, which is adapted to receive an input signal and to provide an output signal. Moreover, the controller 210 is coupled to an event start detector 220 and an event end detector 225. Here, apparatus 200 further comprises a means for signal storing 230, a signal storage memory 240 and a means for signal retrieving 250. The controller 210 is coupled to the means for signal storing 230 in order to direct digital data to the signal storage memory 240, when the event start detector 220 indicates that an unplanned event has occurred. The event end detector 225 would then provide an indication to the controller 210 that the unplanned event has ended, upon which the controller 210, which is coupled to the means for signal retrieving 250, retrieves digital data from the signal storage memory 240 in order to provide said digital data as an output signal.

Generally, embodiments may provide apparatuses and methods for time shifting or delaying playback of broadcast signals, which may be triggered by unplanned events. Embodiments may comprise means for detecting of the starting time of an unplanned event and means for detecting an ending time of the unplanned event. During the time of the unplanned event, embodiments are adapted for storing the broadcasted signal, for example in a storage memory, which may be configured to act as a FIFO buffer. Embodiments can be adapted for providing the stored signals to an output display device after the unplanned event has ended. A controller may control the whole system and may comprise optional ability to reset the state of the memory and erase stored data.

In the absence of an unplanned event, embodiments may just act as a pass through device for the input signal, which can be directly routed to an output device or data destination.

According to FIG. 2, when an unplanned event occurs, for example the start of a phone call, which may be signaled by an event start detector 220, the controller 210 may store the incoming signal, through the means 230 for signal storing, which may be configured to act as a FIFO buffer together with the signal storage memory 240.

After the unplanned event has ended, which may be signaled by the event end detector 225, the controller 210 may start delivering a previously stored signal to the output device instead of the original signal, which is still buffered through the means 230 for storing and the signal storage memory 240. The controller 210 can then utilize the means 250 for signal retrieving for retrieving the previously stored signal from the signal storage memory 240.

The controller 210 also continues directing the incoming signal to the means 230 for signal storing in order to provide uninterrupted broadcast data to a user. Such broadcast will be completely uninterrupted, but effectively time shifted for the duration of the unplanned event or respective pauses.

Optionally, the controller 210 may have an interface for resetting its state, for example by external signaling of such action, a controller 210 would erase the signal storage memory 240 and return the system to an initial state, in which the apparatus 200 may act as a pass-through device again.

Embodiments may comprise optional additional steps, in an embodiment this would include a means for digital signal compression, for example in the means 230 for signal storing, and correspondingly a means for digital signal decompression may be comprised in the means 250 for signal retrieving. Embodiments may therefore minimize or optimize memory usage for the time-shifted signal, respectively for buffered digital data.

Embodiments may be comprised in mobile phones, which can be equipped with optional radio and/or TV receivers, or with alternative means for receiving digital broadcasts, for example by streaming services. Embodiments may utilize the reception of these digital broadcasts by means of the Internet or 3GPP (3GPP=Third Generation Partnership Project) streaming client capabilities. Unplanned events can be triggered by the user or configured to basically any event as for example phone calls or switching of the user focus to some other phone software application, as for example a calendar, address book, etc. In embodiments these events would be signaled by the mobile software or electronic circuits.

Embodiments may also be comprised in a vehicle, for example equipped with entertainment devices capable of receiving audio/video broadcasts, or an in-car phone device. A phone device, signal receiver or display device would be connected to an embodiment. The embodiment could then provide time shifting capabilities for the received broadcast, again for example in the event of an incoming phone call or a stop at, for example, a gas station, etc.

Other embodiments may be comprised in personal computers, laptops, PDAs, etc., as they are for example used in home multimedia centers. Such a device may also be connected to a phone system. Again during an incoming phone call or any other unplanned event, respectively through a user trigger, a signal can be time shifted.

Embodiments therewith enable to time shift real time data or streaming data upon user trigger or defined unplanned events. Embodiments therefore enable continuous reproduction of digital data, even if interruptions or pauses occur.

Embodiments may utilize detection of phone calls on ISDN (ISDN=Integrated Services Digital Network) lines, e.g. interfacing with the CAPI (CAPI=Common ISDN API, Application Programming Interface) protocol, where a telephony agent could scan the activity of the ISDN line and trigger time shifting in case of telephone line activity.

In other embodiments the functionality could be achieved with an analog phone line by a simple electric detector, which could monitor the voltage of the phone line and signal the activity of the line in an active/inactive manner as a trigger for the interruption and provision events.

Other embodiments may be utilized in mobile phones, where a detector could interface with a telephony API of a mobile phone operating system, e.g. Windows Mobile. The operating system could then send line activity statistics to the detector, which would signal out the line state to a controller as interruption or provision events.

Moreover, further embodiments may monitor a microphone input with an appropriate AD (AD=Analogue Digital) conversion interface. Embodiments may use human voice detectors, by e.g. usage of common VAD (VAD=Voice Activity Detection) algorithms as existing as state of the art. In other embodiments a loudness estimation module may be comprised, which measures the loudness of a microphone input. In such an embodiment a microphone would be permanently probed for environmental and other noise in order to detect existence of a human voice and, in case the loudness of such a voice is above a certain threshold, it would assume that the environment is currently being occupied by a discussion and it could then signal the interruption event. Subsequently, it may signal the provision event or stopping of the interruption event when either the loudness drops below the threshold, or a VAD module signals that there is no human speech activity present in the environment any more.

Depending on certain implementation requirements of the inventive methods, the inventive methods can be implemented in hardware or in software. The implementation can be performed using a digital storage medium, in particular a disc, DVD or a CD having electronically readable control signals stored thereon, which cooperate with a programmable computer system, such that the inventive methods are performed. Generally, the present invention is, therefore, a computer program product with a program code stored on a machine-readable carrier, the program code being operated for performing the inventive methods when the computer program runs on a computer. In other words, the inventive methods are, therefore, a computer program having a program code for performing at least one of the inventive methods when the computer program runs of a computer.

1. Apparatus for providing digital data to a data destination, comprising:
a receiver for receiving the digital data;
a detector for detecting an interruption event or a provision event;
a buffer for buffering the digital data; and
a controller for directing the digital data to the buffer after the interruption event was detected and in case the provision event is detected for providing the digital data from the buffer when digital data is present in the buffer or from the receiver otherwise.

2. Apparatus of claim 1, wherein the receiver is adapted for receiving wireless data.

3. Apparatus of claim 2, wherein the receiver is adapted for receiving wireless data via DVB-T, DVB-H, GSM, UMTS, CDMA, 3G, LTE, 802.11, WLAN, Bluetooth or IR.

4. Apparatus of claim 1, wherein the receiver is adapted for receiving digital data over an IP, TCP, HTTP, Ethernet or TV-cable connection.

5. Apparatus of claim 1, wherein the detector is adapted for detecting the interruption event or the provision event exclusively.

6. Apparatus of claim 1, wherein the detector is adapted for detecting the interruption event by detecting an incoming or outgoing phone call.

7. Apparatus of claim 1, wherein the detector is adapted for detecting the interruption event by an interrupt signal from an application or a user.

8. Apparatus of claim 1, wherein the buffer comprises a FIFO buffer, a RAM or a hard drive.

9. Apparatus of claim 1, wherein the buffer is further adapted for receiving a reset indicator and for deleting buffered data upon reception of a reset indicator.

10. Apparatus of claim 1, wherein the controller is adapted for compressing digital data directed to the buffer and for decompressing digital data provided from the buffer.

11. Apparatus of claim 10, wherein the controller is adapted for using a lossy audio or video compression algorithm.

12. Apparatus of claim 1, wherein the controller is adapted for transcoding the digital data directed to the buffer and for transcoding the digital data provided from the buffer.

13. Mobile phone comprising an apparatus according to claim 1.

14. TV set comprising an apparatus according to claim 1.

15. Car entertainment system comprising an apparatus according to claim 1.

16. Personal computer, PDA or laptop comprising an apparatus according to claim 1.

17. Method for providing digital data to a data destination, comprising the steps of:
receiving the digital data;
detecting an interruption event or a provision event;
buffering the digital data; and
directing the digital data to a buffer for buffering after the interruption event was detected and in case the provision event was detected for providing digital data from the buffer when digital data is present in the buffer or from a receiver otherwise.

18. Computer program having a program code for performing the method according to claim 17, when the program code runs on a computer.
